(19) United States
(12) Patent Application Publication
(10) Pub. No.: US 2026/0016349 A1
(43) Pub. Date: Jan. 15, 2026

(54) UNIVERSAL HITCH WITH LOAD CELL TO DETECT PULL FORCE

(71) Applicant: Ati Motors Inc., Milpitas, CA (US)

(72) Inventors: Venkata Hanuma Sai Teja Tiruvallur, Bengaluru (IN); Sagar Hanumantha, Bengaluru (IN); Ritesh Khatavkar, Belagavi (IN); Naveen Arulselvan, Bengaluru (IN)

(73) Assignee: Ati Motors Inc., Milpitas, CA (US)

(21) Appl. No.: 18/771,921

(22) Filed: Jul. 12, 2024

(51) Int. Cl. G01L 1/00; B60D 1/58; G01L 25/00

(52) U.S. Cl. CPC G01L 1/005; B60D 1/58; G01L 25/00

(57) ABSTRACT

According to an embodiment of the present disclosure, universal hitch with load cell (102) to detect pull force is disclosed. The present disclosure provides techniques to automatically measure the pull force experienced by a vehicle such as an autonomous mobile robot (AMR) 100 operating on any attached trolley are provided. The described mechanism may accurately measure the pull force experienced by an AMR 100 while pulling any kind of trolley. The described techniques serve multiple purposes, such as: enabling an AMR 100 to establish its safe operating range within the predefined pull force limits for the given operating conditions, ensuring optimal performance and longevity of the drive system; providing automatic detection mechanisms to identify trolley struck instances; preventing potential damages by overload conditions.

### TECHNICAL FIELD OF THE INVENTION

This invention in general relates to autonomous mobile robots, and specifically to a universal hitch to detect pull force.

### BACKGROUND

Material movement in industrial environments using trolleys can be automated using self-driving robotic vehicles. However, such automated vehicles still rely on manual interaction at the start and destination, e.g., to load or unload material, to check vehicle state, to charge or replace a vehicle battery, etc.

Loading material on a trolley that is then moved to a different location is a common technique for material movement. Trolleys are typically used for moving specific loads across different surfaces. There is no generic design that exists across all trolleys. Different industries create trolleys based on the particular use case. For example, in the automotive industry, examples of loads transported using trolleys can include tyres, engines, engine parts, panels, appliances, electronics components, other trolleys (in case of Mother-Daughter trolleys), etc.

Various techniques can be employed to move a trolley across a factory floor. For example, trolleys may be moved by human workers, tuggers (electric or internal-combustion engine driven), automated guided vehicles (AGVs), and/or autonomous mobile robots (AMRs). During use, the trolley may be employed on various gradients and ramps. In these kinds of use cases, a safety concern arises, e.g., if the trolley has high loads. For example, there may be concerns of rollback when the trolley is stopped on a ramp or any inclined surface. Conventionally, a manual operation to activate brakes is needed to prevent rollback.

### SUMMARY OF THE INVENTION

During the operation of an AMR with an attached trolley, the AMR encounters varying levels of pull force. The level of pull-force depends on several external factors such as payload being carried, the condition of the trolley wheels, coefficient of friction (in turn depends on terrain of operation), gradient of the floor, etc. To ensure safe operation, the AMR (that is attached to a trolley) is designed to operate within a predefined range of pull forces, which in turn can be calibrated for a specific environment. However, excessive or abusive pulling beyond this range can result in accelerated wear and reduced lifespan of the drive system of the AMR. Moreover, it is important to detect instances of the trolley having become stuck, which in turn, can lead to a safety breach.

An AMR or other vehicle is calibrated to operate safely within a predefined range of pull forces. However, instances of abuse beyond this range can lead to reduction in the lifespan of the drive system. Additionally, the setup can be used to detect if the trolley becomes stuck, resulting in a potential breach of safety. By monitoring and analyzing the pull force, the AMR can determine that it is operating within a safe operating range, ensuring optimal performance and safeguarding against potential damage or hazards.

An AMR or other vehicle will need to reliably detect if a trolley is attached and if the trolley is laden or not, during the course of operation through independent means. Accurate pull-force experienced by the AMR or any other vehicle will inform if a laden or unladen trolley is attached. In turn, this may influence the route to be taken. For instance, the AMR or any other vehicle can choose to take a 3-point turn rather than go around a loop if there is no trolley attached. It may also influence the sequence of actions that the AMR has to take. For example, the AMR can automatically drop off the trolley or wait for humans to safely attach a trolley at specific locations.

This disclosure describes techniques to automatically measure the pull force experienced by a vehicle such as an autonomous mobile robot (AMR) operating on any attached trolley. In particular, a universal hitch that can be adapted to work with any kind of trolley is described to enable payload detection.

The described mechanism can accurately measure the pull force experienced by an AMR while pulling any kind of trolley. The described techniques serve multiple purposes, such as: enabling an AMR to automatically establish its safe operating range within the predefined pull force limits for the given operating conditions, ensuring optimal performance and longevity of the drive system; providing automatic detection mechanisms to identify instances where a trolley becomes stuck; preventing potential damage or hazards caused by overload conditions; raising alerts of deterioration in the performance of the AMR or change in operating environment, enabling scheduling of preventive maintenance. The described mechanism is universal as it does not depend on the trolley, the operating environment, or the actual hitching system.

By monitoring and analyzing the pull force, the AMR can make informed decisions about its operating parameters, ensuring the safety of the system and the material being transported. The described techniques provide valuable insights into the dynamic forces exerted on the AMR, facilitate improved operational efficiency and minimize the risk of equipment damage or accidents.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1 illustrates an autonomous mobile robot with a load cell instrumented using a universal hitch, in accordance with some implementations.

FIG. 2 illustrates a close-up view of the universal load cell mounted on a vehicle chassis, in accordance with some implementations.

FIGS. 3A, 3B, 3C and 3D illustrate different views of a load-cell and a universal hitch system, in accordance with some implementations.

FIG. 4 illustrates modules used in instrumenting a load cell with a universal hitch adaptor, in accordance with some implementations.

FIG. 5 illustrates various components in a system comprising a load cell and a universal hitch, in accordance with some implementations.

FIG. 6 illustrates an implementation of a Scott-Russell linkage to translate linear motion of a trolley to a perpendicular direction, in accordance with some implementations.

FIG. 7A illustrates the direction of the compression force on a load cell when a vehicle stops, in accordance with some implementations.

FIG. 7B illustrates the direction of the tensile force on a load cell as a vehicle moves forward, in accordance with some implementations.

FIG. 8 illustrates the pull load monitoring and related processes.

### DETAILED DESCRIPTION OF THE INVENTION

The presently disclosed subject matter now will be described more fully hereinafter with reference to the accompanying figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated figures. Therefore, it is to be understood that the presently disclosed subject matter is not to be limited to the specific embodiments disclosed and that modifications and other embodiments are intended to be included within the scope of the appended claims.

Self-driving vehicles offer many advantages-reduction in expense owing to saving labor costs; suitability for operation in tight spaces where conventional, manually-driven vehicles cannot operate; flexibility in design of shape; etc. Self-driving vehicles can operate in both indoor and outdoor environments. The vehicle and associated systems described herein can achieve autonomous movement in limited mapped environments such as private industrial spaces, warehouses, etc.

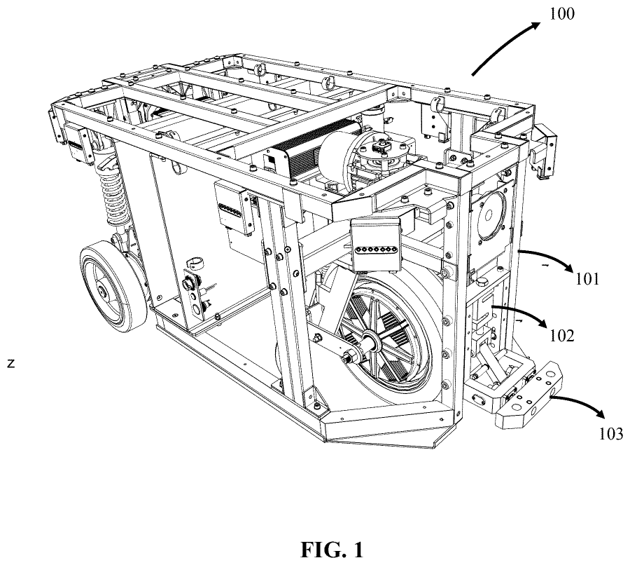

FIG. 1 illustrates an autonomous mobile robot 100 with a load cell 102 instrumented using a universal hitch, in accordance with some implementations. A vehicle chassis and a universal load cell hitch are shown.

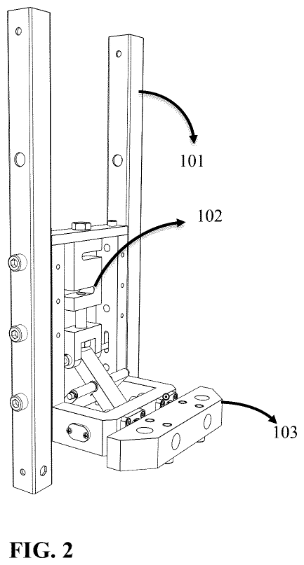

FIG. 2 illustrates a close-up view of the universal load cell mounted on a vehicle chassis, in accordance with some implementations. Chassis beam 101 is a structural component of the vehicle chassis onto which the load cell 102 is mounted. Universal load cell 102 is capable of measuring tension as well as compression forces applied to the system.

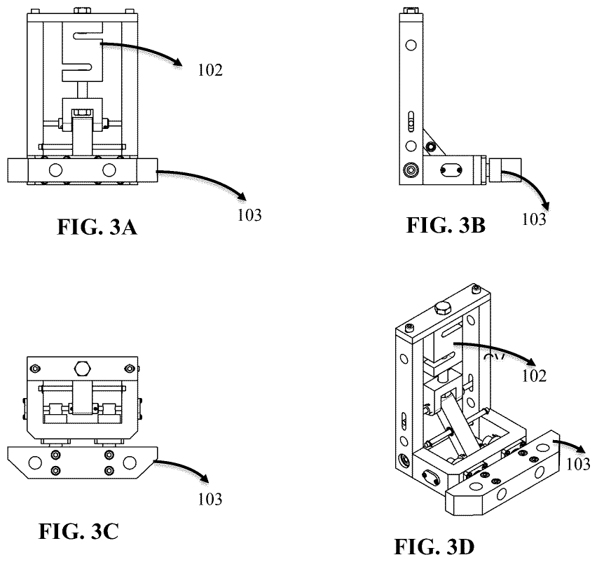

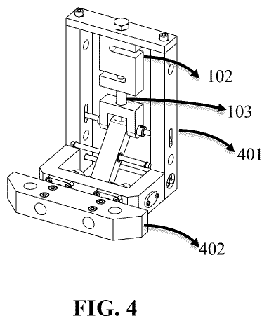

FIG. 3A, FIG. 3B, FIG. 3C, FIG. 3D and FIG. 4 illustrate different views of the load-cell 102 and the universal hitch system, in accordance with some implementations.

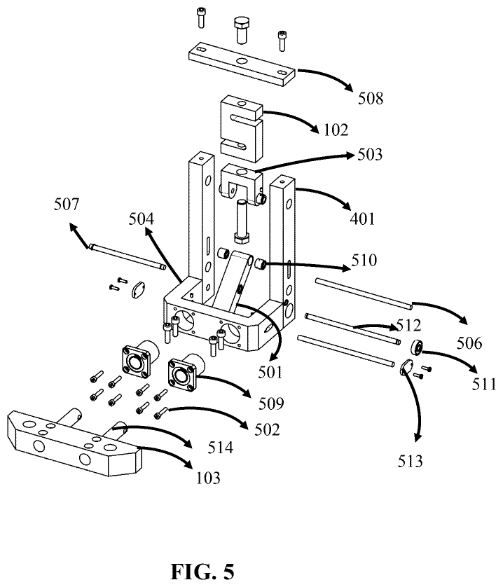

FIG. 5 illustrates sub-systems that instrument load-cell with a universal hitch adaptor, in accordance with some implementations. Load cell mounting plate 508 is a plate to securely hold and position the load cell 102 within the system. S-Type load cell 102 is a specific type of load cell. It is designed to measure tension or compression forces accurately. The load cell 102 converts the applied force into an electrical signal that can be measured and analyzed.

Links 501, 503, 507, 506 directly transfers the pull force of the trolley to the load cell for accurate force measurement. Hitching mount 103 is a mounting that allows the load cell system to be securely attached to a hitch. It provides a reliable connection between the load cell system and the trolley hitch, ensuring that the load cell 102 accurately measures the forces applied during towing or pulling operations. Frame supports 401 on either side are structural elements that provide stability and support to the load cell system. The load cell system connects with the chassis frame.

As illustrated in FIG. 5, there are several subsystems involved in the mechanism. The load cell mounting plate 508 securely holds and positions the load cell within the AMR, ensuring accurate force measurement. The S-type load cell 102, shaped like the letter “S,” is specifically designed to measure tension or compression forces accurately. The S-type load cell also provides a compact form factor. The S-type load cell converts the applied force into electrical signals, which can be measured and analyzed to determine the pull force exerted on the AMR during towing or pulling operations.

Frame supports 401are structural elements that provide support to the load cell system. The frame supports connect with the chassis frame, ensuring the load cell setup remains firmly in place. The hitching mount 103 serves as a reliable mounting mechanism, securely attaching the load cell system to the hitch of the trolley. It enables a robust connection, ensuring accurate measurement of forces and maintaining the alignment between the load cell setup and the trolley hitch.

FIG. 5 illustrates various components in the system comprising a load cell and a universal hitch, in accordance with some implementations. For the sake of brevity, description of certain components has been omitted from the description of components below.

Link 501 is a structural element that connects the vertical member of the vehicle chassis and the load cell. Fasteners 502 are illustrated. Link 503 is a structural element that assists in connecting and aligning the different parts of the load cell system.

Support frame 401 is a rigid structure that holds and stabilizes the load cell 102 and other components. Bearing mount 504 serves as a mounting point for the bearings, allowing smooth rotation and movement.

Pin 1, 506 is a mechanical rod that enables the links to pivot on the right side. Pin 2, 507 is a mechanical rod that enables the links to pivot on the left side.

Load cell mount 508 is a specific mounting bracket designed to securely hold the load cell 102 in place.

Linear bearing 509 allows smooth linear motion and support for the load cell setup. Needle bearing 510 supports smoother pivoting function between the links.

S Type load cell 102 is a specific type of load cell that is designed to measure tension or compression forces accurately. The load cell 102 converts the applied force into an electrical signal that can be measured and analyzed.

Ball bearing 511 facilitates smooth rotational motion and reduces friction in the load cell system.

Pin 512 serves as an additional mechanical rod to connect and secure components of the load cell setup.

Slot cover 513 is a protective cover that prevents debris and contaminants from entering the load cell system.

Hitch mount block 103 is a mounting block specifically designed for attaching any kind of trolley to the load-cell system. Hitch mount rod 514 is a rod-shaped element that connects the load cell setup to the universal hitch through linear bearing 509.

The described implementations include a mechanical setup designed to measure the pull force experienced by an autonomous mobile robot (AMR) 100 or other vehicle 100 while operating with an attached trolley. The primary objective is to detect laden or unladen trolley and to ensure the AMR operates within safe pull force limits. Additionally, the described setup incorporates features to detect if the trolley becomes stuck, causing an overload condition.

To achieve the objectives, several key components are utilized, as described below.

The proposed mechanism utilizes an adaptor block to hitch an AMR (or other vehicle) to any trolley and make a connection to the load cell sensor. The adaptor block features a standard hole hitch, referred to as C-Hitch 103. The C-hitch enables a secure connection between the robot and the trolley, ensuring efficient force transfer during towing or pulling operations.

Support frames on either side 401 hold the load cell setup. The link system transfers the perpendicular pulling force of the trolley to linear force on the S type load cell. Pin 1, 506 and Pin 2, 507 aid as mechanical rods to pivot the link, allowing for flexibility and correct alignment, in order to transfer force to the load cell 102.

The linear bearing 509 enables smooth linear motion and provides support for the load cell setup, reducing friction and ensuring precise force measurements. In addition, all pins 506, 512 that pivot have needle bearings 510 in them. To facilitate smooth rotational motion and reduce friction, a ball bearing is incorporated into the load cell system 511. The needle bearings 510 enable smoother pivoting function between the links.

During operation, as the robot moves forward, the hitched trolley exerts a pull force on the hitch mount block 103. In turn, this causes movement of the hitch mount rod 514 that is attached to the load cell setup through a linear bearing 509. The linear bearing 509 allows for smooth motion with reduced friction.

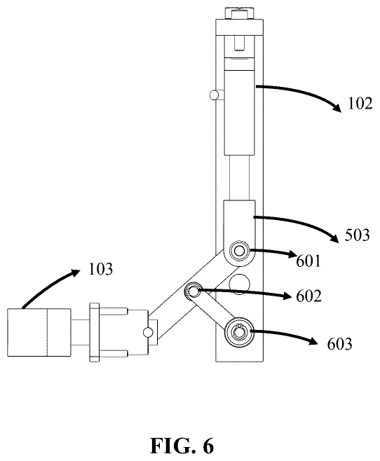

FIG. 6 illustrates an example implementation of a Scott-Russell linkage to translate linear motion of the trolley to a perpendicular direction. Link plates 503, 601, 602, 603 form a Scott-Russell linkage to translate this linear motion to the perpendicular direction.

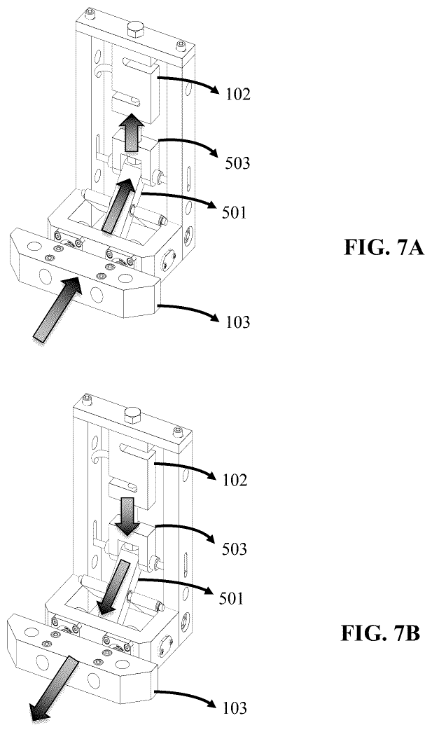

As a result, the S-type load cell 102 experiences a downward tensile force, as illustrated in FIG. 7B, and presents a corresponding electrical signal. Upon prior calibration, the pull force experienced by the vehicle can be calculated from this load-cell measurement. FIG. 7B illustrates the direction of the tensile force on a load cell as a vehicle moves forward, in accordance with some implementations.

When the vehicle stops, a similar transfer of force happens through these links, but in the reverse direction now. Then the S-type load cell 102 experiences an upward compressive force as shown in FIG. 7A. FIG. 7A illustrates the direction of the compression force on a load cell when a vehicle stops, in accordance with some implementations.

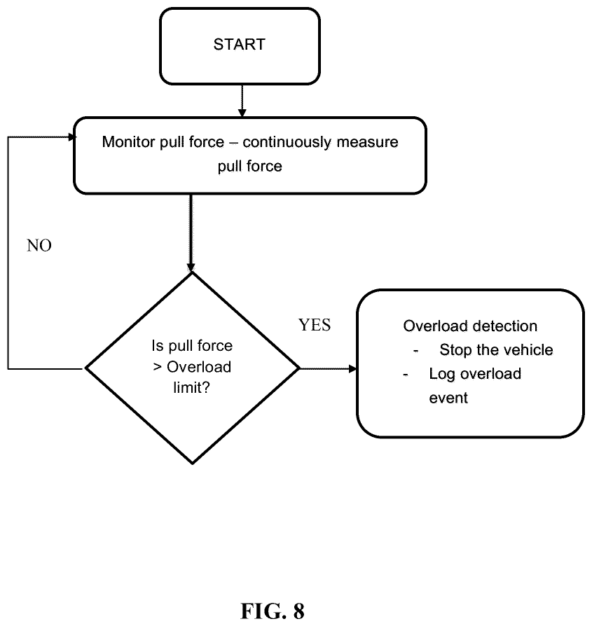

FIG. 8 illustrates the pull load monitoring and related processes.

The universal load cell can be calibrated for a specific operating environment, as there are dependencies such as terrain, inclination, trolley geometry, trolley wheels, payload etc. There are 3 steps for usage of this payload sensor system with a universal hitch:

Step 1: During calibration runs, the typical profile of the load-cell measurements for the specific use-case is captured. After the completion of calibration, the reference load profile is stored, for example in an on-board computer comprising an microcontroller within the autonomous mobile robot. The reference load profile may have spatial dependencies. For instance, there may be specific ramp zones or differing floor quality across the operating environment. To account for such differences, the reference load profile can be stored “zone-wise”.

Step 2: During the normal course of vehicle operation within the environment, the reference load profile at specific locations can be used for detecting the presence of trolley and the payload that is being transported. This, in turn, determines the AMR's routing maneuver's, safety policy decisions and actions to be performed. For instance, AMR can dynamically choose to switch speeds or take longer routes that are uncluttered, when carrying larger payloads. The AMR is well-informed of the business expectations along the route-if the trolley needs to be dropped off or material needs to be picked up. In turn, the AMR can alert the personnel ahead of time for safe and efficient operations. Trip-wise logging of the actual payload data also leads to real-time analytics of the operations.

Step 3: During the normal course of vehicle operation within the environment, anomaly/out-of-sample detection is performed using the reference load profile. Out-of-sample detection implies an extreme loading or a potential safety breach (e.g., trolley wheel is stuck). Out-of-sample detection can be used to trigger an automatic alert to operations personnel (that are responsible for monitoring operation of AMRs in an environment) for their attention.

Further, a frequent or constant shift between the measured load profile and the reference load profile may be detected. Such a shift may imply wear-and-tear, and corresponding need for remedial action such as greasing the trolley wheels, servicing the motor (of the AMR), etc. Detection of such a shift can be used to automatically trigger an alert to service personnel for preventive maintenance.

Step 4: The reference load profile can automatically or manually be re-generated upon change in operating conditions.

A microcontroller within an onboard computer in the vehicle receives and processes information on force measurements from the load cell.

The foregoing examples have been provided merely for explanation and are in no way to be construed as limiting of apparatus disclosed herein. While the apparatus has been described with reference to particular embodiments, it is understood that the words, which have been used herein, are words of description and illustration, rather than words of limitation. Furthermore, although the apparatus has been described herein with reference to particular means, materials, and embodiments, the apparatus is not intended to be limited to the particulars disclosed herein; rather, the design and functionality of the apparatus extends to all functionally equivalent methods, structures and uses, such as are within the scope of the appended claims. While particular embodiments are disclosed, it will be understood by those skilled in the art, having the benefit of the teachings of this specification, that the apparatus disclosed herein is capable of modifications and other embodiments may be effected and changes may be made thereto, without departing from the scope and spirit of the apparatus disclosed herein.

1. A universal hitch mounted on a vehicle chassis, comprising:
a load cell capable of measuring both tension and compression;
a load cell mounting plate that securely holds and positions said load cell;
link system that connects to a vertical member of said vehicle chassis structure, wherein said link directly transfers the pull force of a trolley to the load cell for accurate force measurement;
a rigid support frame that holds and stabilizes said load cell;
bearing mount that serves as a mounting point for bearings, allowing smooth rotation and movement;
a first pin, wherein said first pin is a first mechanical rod that enables said links to pivot on a right side;
a second pin, wherein said second pin is a second mechanical rod that enables said links to pivot on a left side;
wherein said first pin and second pin allow for flexibility and correct alignment, in order to transfer force to the load cell;
load cell mounting bracket to securely hold the load cell in place;
ball bearing that facilitates smooth rotational motion and reduces friction;
a shaft lock that ensures a load cell shaft remains securely in place;
hitching mount that allows the load cell system to be securely attached to a hitch;
frame supports that provide stability and support; and
a microcontroller within an onboard computer in said vehicle that receives and processes information on force measurements on said vehicle from said load cell.

2. The universal hitch of claim 1, wherein said load cell is a S type load cell, and wherein the S-type load cell converts the applied force into electrical signals, which can be measured and analyzed to determine the pull force exerted on the vehicle during towing or pulling operations.

3. The universal hitch of claim 1, further comprising an adapter block to hitch said vehicle to said trolley, wherein said adapter block features a standard hole hitch that enables a secure connection between the vehicle and the trolley, ensuring efficient force transfer during towing or pulling operations.

4. The universal hitch of said claim 1, wherein during calibration runs, a typical profile of load-cell measurements for a specific use-case is captured, and after the completion of calibration, a reference load profile with spatial dependencies is stored.

5. The universal hitch of said claim 1, wherein during normal course of vehicle operation within an environment, anomaly detection is performed using a reference load profile and said anomaly detection triggers an automatic alert to operations personnel.

6. The universal hitch of claim 1, wherein a frequent or constant shift between a measured load profile and a reference load profile may be detected, and inferences are made on wear-and-tear, and corresponding need for remedial action, and wherein said remedial action comprises greasing the trolley wheels, and servicing the vehicle's motor.

7. The universal hitch of claim 1, wherein said vehicle is a mobile robot.

8. The universal hitch of claim 1, wherein said load cell is calibrated for a specific operating environment, wherein said specific environment is dependent on terrain, inclination, trolley geometry, trolley wheels and payload.

9. The universal hitch of claim 1, wherein a reference load profile generated by said local cell determines the AMR's routing maneuver's, safety policy decisions and actions to be performed.

10. The universal hitch of claim 1, wherein a reference load profile generated by said local cell is stored zone-wise.
